(19) United States
(12) Patent Application Publication
(10) Pub. No.: US 2009/0277766 A1
(43) Pub. Date: Nov. 12, 2009

(54) Elastic Member for Pushbutton Switch

(75) Inventor: Yo Fujitsuna, Tokyo (JP)

Correspondence Address: CROMPTON, SEAGER & TUFTE, LLC, 1221 NICOLLET AVENUE, SUITE 800, MINNEAPOLIS, MN, 55403-2420, US

(73) Assignee: POLYMATECH CO., LTD., Chuo-ku, Tokyo (JP)

(21) Appl. No.: 12/090,797

(22) PCT Filed: Oct. 23, 2006
(86) PCT No.: PCT/JP2006/321005

§ 371 Date: Apr. 18, 2008

(30) Foreign Application Priority Data
Oct. 25, 2005 (JP) 2005-310101

(51) Int. Cl. H01H 3/12

(52) U.S. Cl. 200/342

(57) ABSTRACT

An elastic member for a pushbutton switch with which a soft tactile sensation can be gained when the pushbutton is pressed down is provided. The elastic member for a pushbutton switch is provided with a base portion, a connection portion which extends from the base portion, a pressing portion which is supported above the base portion by the connection portion, and a protrusion which protrudes downward from the pressing portion. The inside of the protrusion is hollow.

### TECHNICAL FIELD

The present invention relates to an elastic member for a pushbutton switch with which input operation is carried out for electronics and the like.

### BACKGROUND ART

Conventional pushbutton switches with which input operation is carried out for electronics are provided with an elastic member placed beneath the key-top. This elastic member provides elastic resilience against the operator when the pushbutton is pressed down, and generates a clicking sensation when the pushbutton is displaced by a certain amount in a stroke. As shown in FIG. 9, this conventional elastic member is provided with base portions 3, a connection portions 2 which extends diagonally upward from the base portions 3 and a substantially disc-shaped pressing portion 1 which is supported above the base portions by the connection portions 2. The lower surface of the pressing portion 1 is provided with a protrusion, which is referred to as a pusher 4, for opening and closing the switch circuit through contact with switch elements (not shown) on the switch circuit substrate placed beneath the pressing portion 1.

In such pushbutton switches where elastic deformation of an elastic member is used, the sensation that the operator feels when pressing down the pushbutton switch is characterized by the relationship between the load applied to the pushbutton switch by the operator pressing down the button (load the operator receives from the pushbutton switch) and the distance by which the button is pressed down, that is, the stroke. FIG. 1 shows the load-stroke characteristics of a pushbutton switch in which a conventional elastic member is used. The lateral axis indicates the stroke and the longitudinal axis indicates the load. When the button starts being pressed, the elastic member flexes as the stroke increases, as shown by solid line A, and the load applied to the elastic member also increases. The load reaches the maximum value with a stroke S1. At this point in time, the connection portion 2 of the elastic member starts buckling, and after that the load starts decreasing, as shown by solid line B, and the load becomes the minimum with a stroke S2. Usually, when the button is in the state shown by solid line B, the operator gets a “clicking sensation,” or a sensation that they sense that the button is pressed down. In addition, at the point in time when the load becomes the minimum, the pusher 4 provided on the elastic member makes contact with the switch elements (not shown) provided on the switch circuit substrate placed beneath this elastic member so that the switch circuit is opened or closed. After that, the operator tries to further press down the button for slightly longer in order to make sure that the button is operated, and therefore, the load increases, as shown by solid line C.

Various tactile sensations at the time of operation may be required for such pushbutton switches, depending on the application. In order to gain the desired tactile sensation, it is required in the load-stroke characteristics shown in FIG. 1: (1) that the stroke (peak stroke) S1 before the load reaches the maximum be reduced before a clicking sensation is generated; and (2) that the increase in the resilient load be gentle in the case where additional pressing pressure is applied after the protrusion of the elastic member makes contact with the switch elements, that is to say, for the inclination of solid line C to be gentle.

As a method for meeting the requirement (1), an elastic member may be incorporated in a pushbutton switch in such a state as to be compressed in advance by the housing or the like (hereinafter referred to as advance compression). In addition, as a method for meeting the requirement (2), Patent Document 1, for example, discloses an elastic member shown in FIG. 10. This elastic member is provided with a base portion 3 which is supported by a circuit substrate, a substantially dome-shaped connection portion 2 which continues to the base portion 3, an annular protrusion 13 which continues to the top portion of the connection portion 2, and a substantially disc-shaped thin pressing portion 1 which continues to the inside of the annular protrusion 13. A pusher 4 which protrudes downward and opens and closes the circuit is formed at the center of the lower surface of the pressing portion 1. These components are integrally formed of a rubber elastic body. In this elastic member, the thin pressing portion 1 elastically changes in form when receiving further pressure after connection is made, and therefore, excessive increase in the resilient load is prevented.

In the case where it is additionally desired for the requirement (1) to be met in the elastic member having an annular protrusion in the top portion, which receives pressure, as described in Patent Document 1, however, the form of the pressing portion is sometimes lost, because the annular protrusion is already deformed in the initial state, where the elastic member is incorporated in the pushbutton switch in such a state as to be compressed in advance. Therefore, the stroke S1 intended in the elastic member may not be gained, and it may become difficult to adjust the peak stroke. Furthermore, the annular protrusion, which is expected to elastically change in form after connection is made, is already deformed, and therefore, the desired increase in the resilient load sometimes cannot be gained.

Accordingly, pushbutton switches are advantageous for meeting various requirements in terms of the tactile sensations at the time of operation in the case where it is possible in the load-stroke characteristics of the pushbutton switch shown in FIG. 1 to adjust the rate of load increase, shown by solid line C in FIG. 1, without affecting the peak stroke.

### Patent Document 1: Japanese Laid-Open Patent Publication No. 11-306908

### DISCLOSURE OF THE INVENTION

Accordingly, an objective of the present invention is to provide an elastic member for a pushbutton switch which enables gentle increase in the resilient load in the case where pressing is continued after the protrusion of the elastic member makes contact with the switch elements. Another objective of the present invention is to enable easy adjustment of the peak stroke in the elastic member for a pushbutton switch.

In order to achieve the above described objects and in accordance with one aspect of the present invention, an elastic member for a pushbutton switch is provided. The elastic member includes a base portion, a connection portion which extends from the base portion, a pressing portion which is supported above the base portion by the connection portion, and a protrusion which protrudes downward from the pressing portion. In this elastic member for a pushbutton switch, the protrusion is hollow.

According to one embodiment of the present invention, the pressing portion of the elastic member for a pushbutton switch has an opening which continues from the hollow portion of the protrusion, and the hollow portion and the opening have a constant cross-sectional form.

According to one embodiment, in the case where the protrusion is substantially cylindrical, the inner diameter of the hollow portion of this protrusion is preferably 40% to 90%, and more preferably 40% to 80% of the outer diameter of the protrusion.

According to one embodiment, the base portion is annular and shaped like a plate, the connection portion is shaped like a truncated cone and extends diagonally upward from the inner periphery of the base portion, and the pressing portion is substantially shaped like a disc.

According to one embodiment, the base portion is made up of a pair of prism shaped base portions which are placed at a distance from each other, the connection portion is shaped like a thin plate and extends diagonally upward from the respective upper ends of the pair of base portions which face each other, and the pressing portion is shaped like a rectangular plate. Furthermore, the hollow portion of the protrusion may have an opening on a side of the protrusion.

According to one embodiment, the elastic member for a pushbutton switch may be provided with a conductive portion on the lower surface of the protrusion.

The elastic member for a pushbutton switch may be formed of a rubber-like elastic body.

According to one embodiment, the rubber-like elastic body may be made of silicone rubber.

### BRIEF DESCRIPTION OF THE DRAWINGS

FIG. 1 is a graph showing the load-stroke characteristics of a pushbutton switch using a conventional elastic member for a pushbutton switch;

FIG. 2 is a perspective view showing an elastic member according to a first embodiment of the present invention;

FIG. 3 is a longitudinal cross-sectional view showing the elastic member according to the first embodiment of the present invention;

FIG. 4 is a longitudinal cross-sectional view showing the structure for a pushbutton switch in which the elastic member according to the first embodiment of the present invention is incorporated;

FIG. 5 is a longitudinal cross-sectional view showing the structure for the pushbutton switch in which the elastic member according to the first embodiment of the present invention is incorporated;

FIG. 6 is a longitudinal cross-sectional view showing the structure for the pushbutton switch in which the elastic member according to the first embodiment of the present invention is incorporated;

FIG. 7 is a perspective view showing an elastic member according to a second embodiment of the present invention;

FIG. 8 is a perspective view showing an elastic member according to a third embodiment of the present invention;

FIG. 9 is a longitudinal cross-sectional view showing a conventional elastic member;

FIG. 10 is a longitudinal cross-sectional view showing another conventional elastic member;

FIG. 11(a) is a graph showing the load-stroke characteristics in the structure for a pushbutton switch using the elastic member of Example 1; FIG. 11(b) is a graph showing the load-stroke characteristics in the structure for a pushbutton switch using the elastic member of Comparative Example 1; FIG. 11(c) is a graph showing the load-stroke characteristics in the structure for a pushbutton switch using the elastic member of Comparative Example 2; FIG. 11(d) is a graph showing the load-stroke characteristics in the structure for a pushbutton switch using the elastic member of Comparative Example 3; and

FIG. 12(a) is a graph showing the load-stroke characteristics in the structure for a pushbutton switch using the elastic member of Example 2; FIG. 12(b) is a graph showing the load-stroke characteristics in the structure for a pushbutton switch using the elastic member of Example 3; and FIG. 12(c) is a graph showing the load-stroke characteristics in the structure for a pushbutton switch using the elastic member of Example 4.

### BEST MODE FOR CARRYING OUT THE INVENTION

### First Embodiment

FIGS. 2 and 3 are a perspective view and a longitudinal cross-sectional view, each showing an elastic member 100 according to a first embodiment of the present invention.

The elastic member 100 is provided with an annular plate-shaped base portion 3, a connection portion 2 which is thin and extends diagonally upward from the inner periphery of the base portion 3, and a substantially disc-shaped pressing portion 1 which is supported above the base portion 3 by the connection portion 2. According to the present embodiment, as shown in FIG. 2, the connection portion 2 is shaped like a reverse funnel (a truncated cone) and converges upward. The pressing portion 1 is provided with a protrusion which protrudes downward from the lower surface of the pressing portion 1, that is to say, a pusher 4. The lower surface 4a of the pusher 4 is located above the lower surface 3a of the base portion 3. A hollow portion 5 is created inside the pusher 4 and an opening 6 which continues from the hollow portion 5 of the pusher 4 is created in the pressing portion 1. As shown in FIG. 3, the hollow portion 5 of the pusher 4 and the opening 6 in the pressing portion 1 have the same, uniform inner diameter, and at the same time, make up a single hole having a bottom as well as an opening on the upper surface 1a of the pressing portion 1.

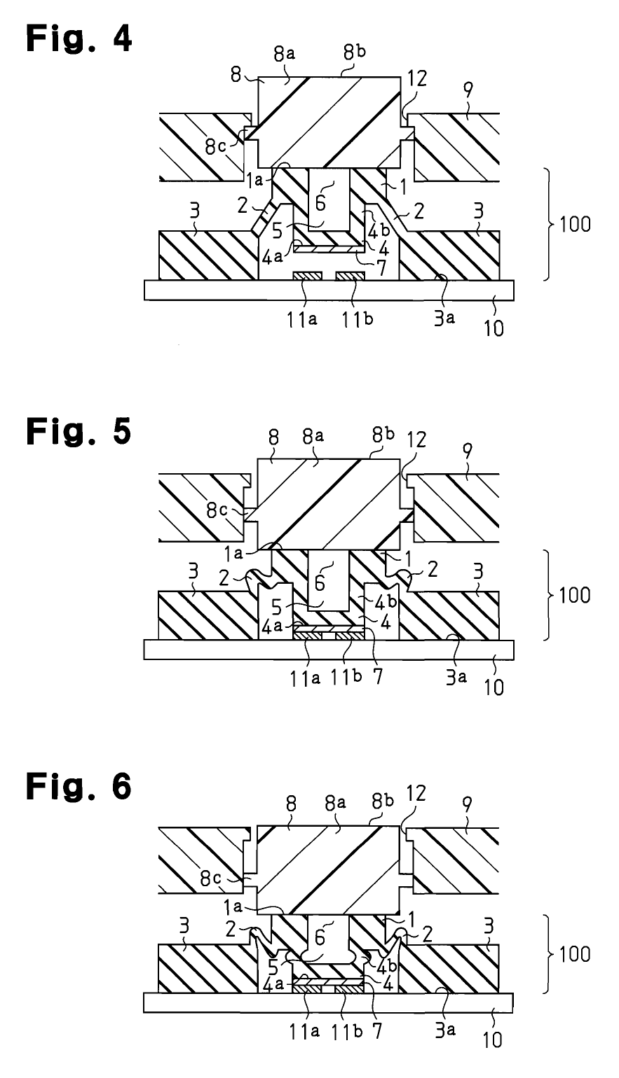

FIG. 4 shows an example of the structure for a pushbutton switch using the elastic member 100 according to the first embodiment. This structure for a pushbutton switch is provided with a key-top 8, a housing 9, an elastic member 100, and a circuit substrate 10. The housing 9 is a portion of the housing of an electronic device in which the structure for a pushbutton switch is provided. The key-top 8 is provided with a substantially columnar main body portion 8a and a pressing surface 8b which is pressed by the operator at the time of operation. In the main body portion 8a, a flange 8c which protrudes outward in the direction of the diameter from a location slightly beneath the center of the outer peripheral surface of the main body portion is formed. An opening 12 in such a form as to correspond to the form of the key-top 8 is provided in the housing 9. The inner diameter of the opening 12 is greater than the outer diameter of the main body portion 8a of the key-top 8 and smaller than the outer diameter of the flange 8c.

The key-top 8 is arranged so that the pressing surface 8b protrudes from the upper surface of the housing 9 through the opening 12 in the housing 9.

The elastic member 100 is placed beneath the key-top 8. In the elastic member 100 according to the present embodiment, a conductive portion 7 is additionally formed on the lower surface 4a of the pusher 4. This conductive portion 7 can be formed by applying a conductive ink, for example, at the end of the pusher 4. A circuit substrate 10 is placed beneath the elastic member 100. A pair of electrical contacts 11a and 11b are provided as switch elements for opening and closing the electrical circuit provided on the circuit substrate 10. The conductive portion 7 of the elastic member 100 and the electrical contacts 11a and 11b on the circuit substrate 10 are placed in such a manner as to face each other.

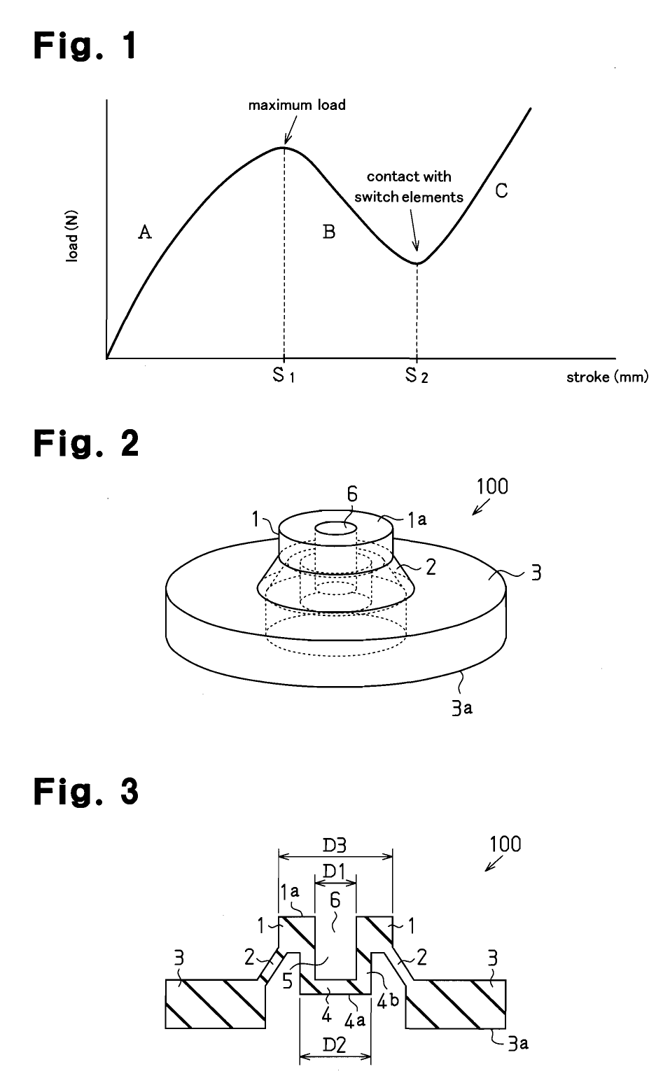

In this structure for a pushbutton switch, when the key-top 8 is pressed down, the pressing portion 1 of the elastic member 100 is pressed in such a manner that the connection portion 2 elastically changes in form, and shortly thereafter the connection portion 2 buckles, as shown in FIG. 5. Together with this, the pusher 4 moves downward, and as shown in FIG. 5, the conductive portion 7 formed on the lower surface 4a of the pusher 4 makes contact with the electrical contacts 11a and 11b. As a result, the electrical contacts 11a and 11b are electrically connected, so that the electrical circuit on the circuit substrate 10 is opened or closed. When the key-top 8 is further pressed down after the electrical contacts 11a and 11b are electrically connected, the outer peripheral wall 4b of the pusher 4 bends significantly as shown in FIG. 6, because the inside of the pusher 4 is hollow. In this manner, the outer peripheral walls 4b of the pusher 4 bend in the elastic member 100 according to the present embodiment, and thus, the increase in the resilient load provided to the operator by the elastic member 100 becomes small in comparison with conventional elastic members, which do not have a hollow portion inside the pusher. That is to say, the inclination of the solid line C indicating the load-stroke characteristics of the elastic member 100 after connection is made becomes gentle, as in FIG. 1. As a result, it becomes possible to provide a softer tactile sensation to the operator. In addition, it is possible in the elastic member 100 to adjust the rate of load increase (inclination of solid line C in FIG. 1) after the pusher 4 makes contact with the electrical contacts 11a and 11b in the manner by changing the thickness of the outer peripheral wall 4b of the pusher 4, that is to say, the ratio of the inner diameter D1 of the hollow portion 5 to the outer diameter D2 of the pusher 4.

The elastic member 100 according to the present invention is formed of a material having rubber elasticity (rubber-like elastic body). This material may be a synthetic rubber, such as silicone rubber, urethane rubber and ethylene propylene rubber, in addition to styrene based, olefin based, polyester based and urethane based thermoplastic elastomers. From among the materials, silicone rubber is preferable, because it has little permanent distortion when compressed and is excellent in terms of durability. In order to gain rubber elasticity, it is preferable for the hardness of the material for forming the elastic member 100 to be 30 to 70 (values measured using type A durometer in compliance with JIS-K6253 (corresponding to ISO 7619-1)). Furthermore, in the case where the pushbutton switch is illuminated by providing a light source beneath the elastic member 100, it is preferable for the elastic member 100 to have translucency.

It is preferable for the inner diameter D1 in the hollow portion 5 of the pusher 4 shown in FIG. 3 to be 40% to 90% of the outer diameter D2 of the pusher 4 in the elastic member 100 according to the above described embodiment. It is more preferable for the inner diameter D1 in the hollow portion 5 of the pusher 4 to be 40% to 80% of the outer diameter D2 of the pusher 4. In the case where the inner diameter D1 in the hollow portion 5 of the pusher 4 is less than 40% of the outer diameter D2 of the pusher 4, it becomes difficult for the pusher 4 to bend as described above. On the other hand, in the case where the ratio exceeds 90%, the pusher 4 becomes too flexible. Accordingly, in either case, the desired load characteristics cannot be gained. In addition, in the case where the inner diameter D1 in the hollow portion 5 of the pusher 4 exceeds 90% of the outer diameter D2 of the pusher 4, the pusher 4 becomes less durable, which is not preferable.

In the elastic member 100 according to the first embodiment, the pusher 4 has a hollow portion 5, and therefore, the pusher 4 easily bends when pressed in comparison with the case where the pusher is solid. Therefore, increase in the resilient load becomes small after the pusher 4 makes contact with the electrical contacts 11a and 11b. As a result, a softer tactile sensation is provided to the operator.

In the elastic member 100, the ratio of the inner diameter D1 of the hollow portion 5 to the outer diameter D2 of the pusher 4 can be changed, and thus, the rate of load increase (inclination of solid line C in FIG. 1) can be changed after the pusher 4 makes contact with the electrical contacts 11a and 11b. As a result, it becomes possible to adjust the tactile sensation provided to the operator in accordance with the requirements.

In the elastic member 100, in the case where the inner diameter D1 in the hollow portion 5 of the pusher 4 is in a range from 40% to 90% of the outer diameter D2 of the pusher 4, the desired load characteristics are gained after the pusher 4 makes contact with the electrical contacts 11a and 11b as described above, and at the same time, the durability is ensured secured for the pusher 4.

In order to gain a soft tactile sensation, the elastic member 100 does not have an annular protrusion on the upper surface of the pressing portion 1, unlike conventional elastic members. Therefore, in the case where the structure for a pushbutton switch is formed in a state where the elastic member 100 is compressed in advance, it is not necessary to take deformation of the annular protrusion due to advance compression into consideration, and therefore, it becomes easy to adjust the peak stroke. In addition, the rate of load increase after the pusher 4 makes contact with the electrical contacts 11a and 11b can be adjusted in the elastic member 100, as described above, by changing the ratio of the inner diameter D1 in the hollow portion 5 to the outer diameter D2 of the pusher 4 while barely affecting the peak stroke S1.

In the case where an opening 6 which continues from the hollow portion 5 of the pusher 4 is created in the pressing portion 1 in the elastic member 100, the air inside the hollow portion 5 easily escapes to the outside when the pusher 4 is compressed through pressing. In addition, it becomes easy to create a hollow structure for the pusher 4 in a manufacturing process.

### Second Embodiment

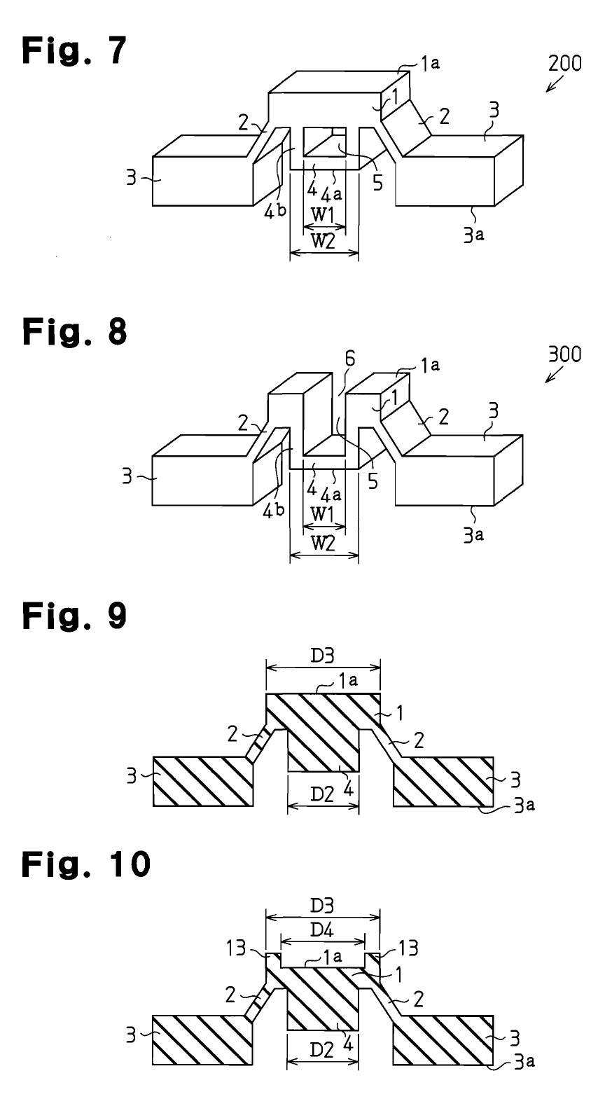

FIG. 7 is a perspective view showing the elastic member 200 according to a second embodiment of the present invention.

The elastic member 200 is provided with a pair of prism shaped base portions 3 which are placed at a distance from each other, thin plate shaped connection portions 2 which respectively extend diagonally upward from the upper end of these two base portions 3 which face each other, and a pressing portion 1 shaped like a rectangular plate which is supported above the base portions 3 by the connection portions 2. The pressing portion 1 is provided with a substantially prism shaped pusher 4 which protrudes downward from the lower surface of the pressing portion 1. The lower surface 4a of the pusher 4 is located above the lower surface 3a of the base portions 3. A hollow portion 5 having openings on the two sides of the pusher 4 is created in the pusher 4.

### Third Embodiment

FIG. 8 is a perspective view showing an elastic member 300 according to a third embodiment of the present invention.

The elastic member 300 has the same structure as the elastic member 200, except that an opening 6 which continues from the hollow portion 5 of the pusher 4 is created on the upper surface 1a of the pressing portion 1. The hollow portion 5 of the pusher 4 and the opening 6 of the pressing portion 1 have a constant lateral cross-sectional form. As shown in FIG. 8, the opening 6 of the pressing portion 1 and the hollow portion 5 of the pusher 4 make the pressing portion 1 and the pusher 4 of a U shape as a whole.

In the case where the elastic member 200 or 300 is incorporated in the structure for a pushbutton switch for use, the connection portions 2 elastically change in form and buckle when the pressing portion 1 of the elastic member 200 or 300 is pressed, so that the lower surface 4a of the pusher 4 makes contact with the switch elements (not shown) on the circuit substrate provided beneath the elastic member 200 or 300, and thus, the electric circuit on the circuit substrate is opened or closed, in the same manner as the elastic member 100 in FIG. 6. After that, in the case where the pressing portion 1 is further pressed, the outside walls 4b of the pusher 4 bend. As a result, a soft tactile sensation is provided to the operator.

In the elastic members 200 and 300 according to the second and third embodiments, the inclination of solid line C in FIG. 1, that is to say, the rate of load increase, can be changed by changing the ratio of the width W1 in the hollow portion 5 to the width W2 of the pusher 4 shown in FIGS. 7 and 8.

It is preferable for the width W1 in the hollow portion 5 of the pusher 4 to be 40% to 90% of the width W2 of the pusher 4. In the case where the width W1 in the hollow portion 5 of the pusher 4 is less than 40% of the width W2 of the pusher 4, it becomes difficult for the pusher 4 to deform, while in the case where the ratio exceeds 90%, the pusher 4 becomes too flexible, and in either case, the desired load characteristics cannot be gained. In addition, in the case where the width W1 in the hollow portion 5 of the pusher 4 exceeds 90% of the width W2 of the pusher 4, the pusher 4 becomes less durable, which is not preferable.

The elastic members 200 and 300 according to the second and third embodiments can be formed of the same material as the elastic member 100 according to the first embodiment. In addition, it is preferable for the hardness of the material for forming the elastic members 200 and 300 to be 30 to 70 (values measured using type A durometer in compliance with JIS-K 6253 (corresponding to ISO 7619-1)), as in the case of the first embodiment. Furthermore, in the case where the pushbutton switch is illuminated by providing a light source beneath the elastic member 200 or 300, it is preferable for the elastic member 200 or 300 to have translucency.

The elastic members 200 and 300 according to the second and third embodiments may be incorporated in the structure for a pushbutton switch in the same manner as the elastic member 100 according to the first embodiment, and at the same time, provide the same advantages.

Furthermore, the connection portions 2 and the base portions 3 are formed only on the sides of the pressing portion 1, and therefore, the area where the elastic members 200 and 300 according to the second and third embodiment are installed can be reduced, and at the same time, it becomes possible to place these members in closer proximity to other parts.

It is also possible to modify the above described embodiments as follows.

In the first embodiment, the opening 6, which continues from the hollow portion 5 of the pusher 4, does not need to be created in the pressing portion 1. In this case, it is preferable to provide an air escape for air inside the hollow portion 5 to escape when the pusher 4 is compressed through pressing in at least either the pressing portion 1 or the pusher 4.

In the first embodiment, the form of the base portion 3 is not particularly limited, and may be any form.

In the second embodiment, the hollow portion 5 of the pusher 4 does not need to have an opening on the sides of the pusher 4.

In the second and third embodiments, a conductive portion may be provided on the lower surface 4a of the pusher 4.

In the case where the elastic member 100, 200 or 300 according to any of the first to third embodiments is incorporated in the structure for a pushbutton switch, the elastic member 100, 200 or 300 may be sandwiched between the housing 9, the key-top 8 and the circuit substrate 10 in such a state as to be compressed in advance in the direction in which the key-top 8 is pressed down. In this configuration, the peak stroke can be adjusted to a desired level.

In the structure for a pushbutton switch in which the elastic member 100, 200 or 300 according to any of the first to third embodiments is incorporated, pressure sensitive switch elements may be used as switch elements placed on the circuit substrate 10. In this case, it becomes unnecessary to form a conductive portion 7 on the lower surface 4a of the pusher 4 of the elastic member 100, 200 or 300.

### EXAMPLES

### Example 1

The elastic member 100 shown in FIGS. 2 and 3 was fabricated using silicone rubber (“SH861U,” made by Dow Corning Toray Co., Ltd.). In the elastic member 100 of Example 1, the ratio of the inner diameter D1 in the hollow portion 5 of the pusher 4, the outer diameter D2 of the pusher, and the outer diameter D3 of the pressing portion 1 was set to 0.60:1:1.6. Accordingly, the ratio of the inner diameter D1 of the hollow portion 5 of the pusher 4, the outer diameter D2 of the pusher, and the outer diameter D3 of the pressing portion 1 is as shown in Table 1.

### Examples 2 to 4

The elastic members of Examples 2 to 4 were respectively fabricated using the same material as in Example 1, without changing the outer diameter D2 of the pusher 4 and the outer diameter D3 of the pressing portion 1, but changing the inner diameter D1 in the hollow portion 5 of the pusher 4, in the form of the elastic member 100 of Example 1. In the elastic members of Examples 2 to 4, the ratio was set as shown in Table 1 for each of the inner diameter D1 in the hollow portion 5 of the pusher 4 to the outer diameter D2 of the pusher 4 and the outer diameter D3 of the pressing portion 1.

### Comparative Example 1

A conventional elastic member as that shown in FIG. 9 was fabricated using silicone rubber (“SH861U,” made by Dow Corning Toray Co., Ltd.). This elastic member had substantially the same form as the elastic member 100 of Examples 1 to 4, but the pusher 4 and the pressing portion 1 were formed in such a manner as to be solid. In Comparative Example 1, the ratio of the outer diameter D2 of the pusher to the outer diameter D3 of the pressing portion 1 was set to 1:1.6.

### Comparative Example 2

A conventional elastic member as that shown in FIG. 10 was fabricated using silicone rubber (“SH861U,” made by Dow Corning Toray Co., Ltd.). This elastic member had the same structure as in Comparative Example 1, except that an annular protrusion 13 was provided around the upper surface 1a of the pressing portion 1. In Comparative Example 2, the ratio of the inner diameter D4 of the annular protrusion 13, the outer diameter D2 of the pusher 4, and the outer diameter D3 of the pressing portion 1 was set to 1.2:1:1.6. Accordingly, the ratio of the inner diameter D4 of the annular protrusion 13 to the outer diameter D3 of the pressing portion 1 is as shown in Table 1.

### Comparative Example 3

A conventional elastic member as that shown in FIG. 10 was fabricated using silicone rubber (“SH861U,” made by Dow Corning Toray Co., Ltd.). This elastic member had the same structure as in Comparative Example 1, except that an annular protrusion 13 was provided around the upper surface 1a of the pressing portion 1. In Comparative Example 3, the ratio of the inner diameter D4 of the annular protrusion 13, the outer diameter D2 of the pusher 4, and the outer diameter D3 of the pressing portion 1 was set to 1.28:1:1.6. Accordingly, the ratio of the inner diameter D4 of the annular protrusion 13 to the outer diameter D3 of the pressing portion 1 is as shown in Table 1.

### Comparative Examples 4 and 5

The elastic members of Comparative Examples 4 and 5 were respectively fabricated using the same material as in Example 1, without changing the outer diameter D2 of the pusher 4 and the outer diameter D3 of the pressing portion 1, but changing the inner diameter D1 in the hollow portion 5 of the pusher 4, in the form of the elastic member 100 of Example 1. In the elastic members of Comparative Examples 4 and 5, the ratio was set as shown in Table 1 for each of the inner diameter D1 in the hollow portion 5 of the pusher 4 to the outer diameter D2 of the pusher 4 and the outer diameter D3 of the pressing portion 1.

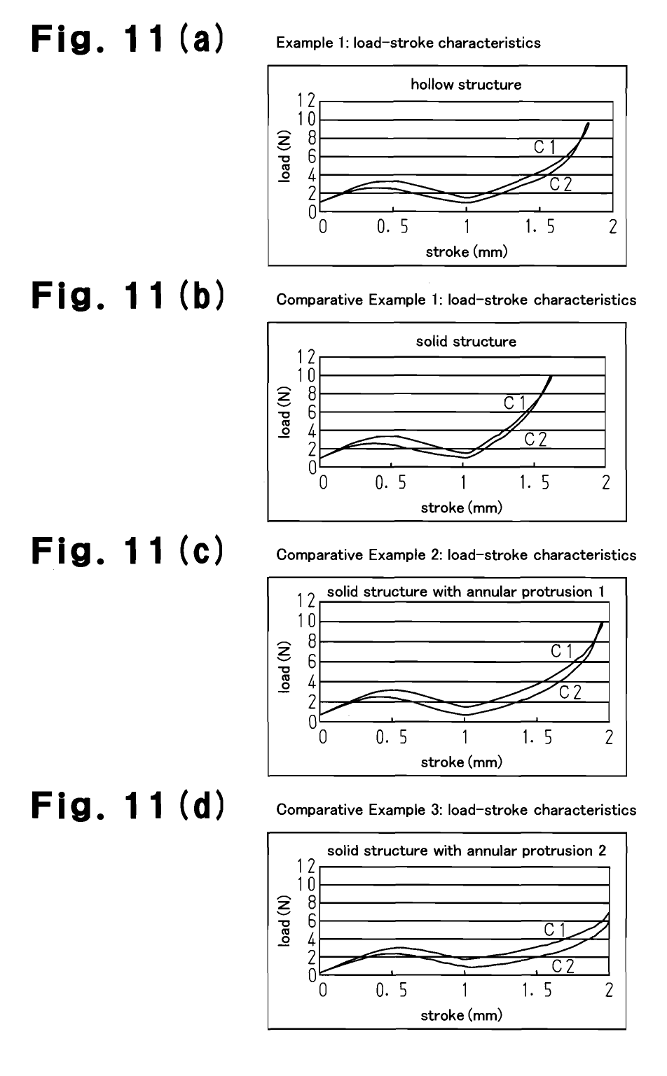

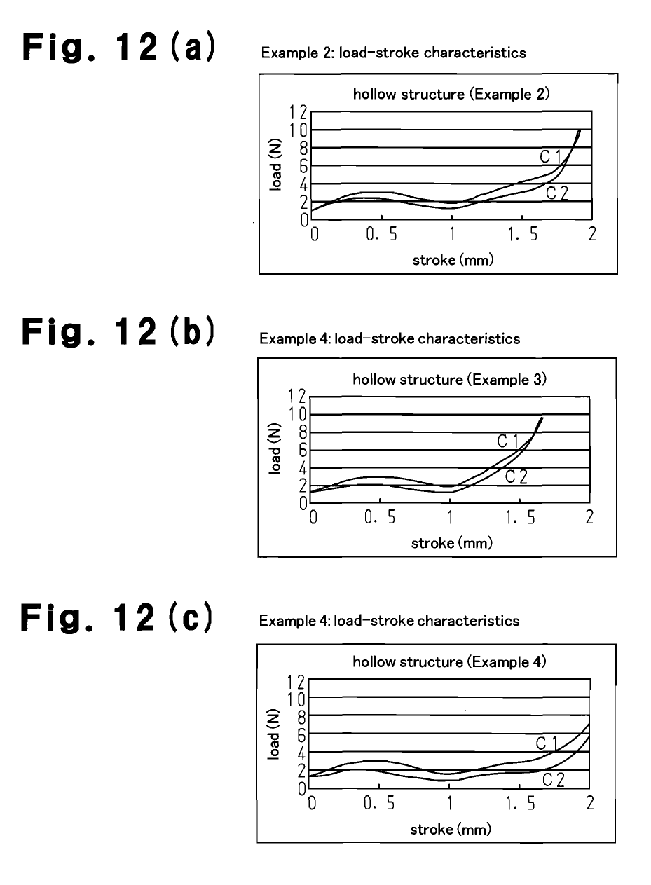

The respective elastic members of Examples 1 to 4 and Comparative Examples 1 to 5 were used to fabricate structures for a pushbutton switch as that shown in FIG. 4, and the load-stroke characteristics when each structure for a pushbutton switch was pressed down were measured. At this time, each elastic member was adjusted through advance compression so that the stroke with which the lower surface of the pusher of each elastic body makes contact with the contacts on the switch circuit substrate (on stroke) became substantially 1 mm. FIGS. 11(a) to 11(d) show hysteresis curves showing the load-stroke characteristics of the structure for a pushbutton switch of Example 1 and Comparative Examples 1 to 3 as examples, and FIGS. 12(a) to 12(c) show hysteresis curves showing the characteristics of the structure for a pushbutton switch of Examples 2 to 4. In each of the hysteresis curves, curve C1 on the upper side indicates the characteristics when the button is pressed down and curve C2 on the lower side indicates the characteristics when the button returns to its original position after the pressing operation is stopped. In addition, Table 1 shows the peak stroke S1 and the ratio of increase from the point in time when the lower surface of load the pusher made contact with the contacts on the switch circuit substrate to the point where the button was further pressed in by 0.5 mm. This rate of load increase was found from the following expression, using each of the load-stroke curves C1 shown in FIGS. 11 to 12.

Rate of load increase=(load when stroke 1.5 mm−load when stroke 1.0 mm)/0.5 mm

TABLE 1

| | Ratio of inner | Ratio of inner diameter D1 of | | |
|---|---|---|---|---|
| | diameter D1 in hollow | hollow portion or inner diameter | Peak | Rate of load |
| | portion to outer | D4 of annular recess to outer | stroke | increase |
| | diameter D2 of pusher | diameter D3 of pressing portion | S₁ (mm) | (N/mm) |
| Example 1 | 60% | 37.5% | 0.43 | 5.84 |
| Example 2 | 68% | 42.5% | 0.44 | 5.08 |
| Example 3 | 40% | 30% | 0.46 | 8.48 |
| Example 4 | 80% | 50% | 0.45 | 2.82 |
| Comparative | — | — | 0.45 | 11.08 |
| Example 1 | | | | |
| Comparative | — | 75% | 0.49 | 4.64 |
| Example 2 | | | | |
| Comparative | — | 80% | 0.54 | 2.88 |
| Example 3 | | | | |
| Comparative | 32% | 20% | 0.44 | 10.06 |
| Example 4 | | | | |
| Comparative | 92% | 57.5% | 0.46 | 1.22 |
| Example 5 | | | | |

In the elastic members of Examples 1 to 4, the pusher 4 had a hollow structure, and therefore, the rate of load increase became small after the lower surface of the pusher 4 made contact with the contacts on the circuit substrate, so that a soft tactile sensation was gained. In addition, in the elastic member of Example 1, even when compressed in advance, the peak stroke S1 barely changed in comparison with the elastic member having a solid pressing portion of Comparative Example 1. This is considered to be because the inner diameter D1 in the hollow portion 5 of the pusher 4 was set sufficiently small relative to the outer diameter D3 of the pressing portion 1 in the elastic members of Examples 1 to 4, and therefore, the upper surface of the pressing portion 1 barely deformed, even when compressed in advance. As a result, in Examples 1 to 4, the ratio of the inner diameter D1 in the hollow portion 5 to the outer diameter D2 of the pusher 4 was changed within a predetermined range (from 40% to 80%), and thus, the rate of load increase could be adjusted within a range of 2.82 N/mm to 8.48 N/mm while barely changing the peak stroke S1.

In contrast, the rate of load increase was great in the elastic member of Comparative Example 1 after the lower surface of the pusher 4 made contact with the contacts on the circuit substrate, and therefore, the desired tactile sensation was not gained. In addition, it was possible to reduce the increase in the load after contact was made in the elastic members of Comparative Examples 2 and 3. In the elastic members of Comparative Examples 2 and 3, however, the ratio of the inner diameter D4 of the annular protrusion 13 to the outer diameter D3 of the pressing portion 1 was considerably great in comparison with the ratio of the inner diameter D1 in the hollow portion 5 of the pusher 4 to the outer diameter D3 of the pressing portion 1 in Example 1, as shown in Table 1. Therefore, in the elastic members of Comparative Examples 2 and 3, the annular protrusion 13 was deformed through advance compression, and therefore, the peak stroke changed greatly. Accordingly, it was difficult to adjust the load curve for the elastic members of Comparative Examples 2 and 3, where the annular protrusion 13 was provided. In the elastic member of Comparative Example 4, the rate of load increase became great after the lower surface of the pusher 4 made contact with the contacts on the circuit substrate, and the desired tactile sensation was not gained. This is considered to be because the inner diameter D1 in the hollow portion 5 of the pusher 4 was small relative to the outer diameter D2 of the pusher and the ratio thereof was 32% in the elastic member of Comparative Example 4, and therefore, the outer peripheral wall 4b of the pusher was thick, making it difficult for the outer peripheral wall 4b of the pusher 4 to bend when pressed. In the elastic member of Comparative Example 5, the inner diameter D1 in the hollow portion 5 of the pusher 4 was too great relative to the outer diameter D2 of the pusher 4 and the ratio thereof was 92%, and therefore, the outer peripheral wall 4b of the pusher 4 was thin, making the pusher 4 excessively flexible. Therefore, in the elastic member of Comparative Example 5, the rate of load increase became extremely small after the lower surface of the pusher 4 made contact with the contacts on the circuit substrate, and thus, the desired tactile sensation was not gained. In addition, it is also possible in the elastic member of Comparative Example 5 that a problem may arise with the durability, because the outer peripheral wall 4b of the pusher 4 is excessively thin.

1. An elastic member for a pushbutton switch, comprising: a base portion; a connection portion which extends from the base portion; a pressing portion supported above the base portion by the connection portion; and a protrusion which protrudes downward from the pressing portion,
wherein the protrusion is hollow.

2. The elastic member for a pushbutton switch according to claim 1, wherein the pressing portion has an opening which continues from the hollow portion in the protrusion, and the hollow portion and the opening have a constant lateral cross-sectional form.

3. The elastic member for a pushbutton switch according to claim 1, wherein the protrusion is substantially cylindrical and the inner diameter in the hollow portion of the protrusion is 40% to 90% of the outer diameter of the protrusion.

4. The elastic member for a pushbutton switch according to claim 3, wherein the inner diameter in the hollow portion of the protrusion is 40% to 80% of the outer diameter of the protrusion.

5. The elastic member for a pushbutton switch according to claim 1, wherein the base portion is annular and shaped like a plate, the connection portion is shaped like a truncated cone and extends diagonally upward from the inner periphery of the base portion, and the pressing portion is substantially shaped like a disc.

6. The elastic member for a pushbutton switch according to claim 1, wherein the base portion is made up of a pair of prism-shaped base portions which are placed at a distance from each other, the connection portion is shaped like a thin plate and extends diagonally upward from the upper end of each of the pair of base portions which face each other, and the pressing portion is shaped like a rectangular plate.

7. The elastic member for a pushbutton switch according to claim 6, wherein the hollow portion of the protrusion has an opening on a side of the protrusion.

8. The elastic member for a pushbutton switch according to claim 1, wherein a conductive portion is provided on the lower surface of the protrusion.

9. The elastic member for a pushbutton switch according to claim 1, wherein the elastic member is formed of a rubber-like elastic body.

10. The elastic member for a pushbutton switch according to claim 9, wherein the rubber-like elastic body is made of silicone rubber.
